(19) United States
(12) Patent Application Publication
(10) Pub. No.: US 2006/0204816 A1
(43) Pub. Date: Sep. 14, 2006

(54) Fuel cell device and electronic appliance

(75) Inventor: Atsushi Yamaguchi, Kawasaki (JP)

Correspondence Address: ARENT FOX PLLC, 1050 CONNECTICUT AVENUE, N.W., SUITE 400, WASHINGTON, DC, 20036, US

(73) Assignee: Fujitsu Limited

(21) Appl. No.: 11/177,577

(22) Filed: Jul. 11, 2005

(30) Foreign Application Priority Data
Mar. 10, 2005 (JP) 2005-067865

(51) Int. Cl. H01M 8/04; H01M 8/10

(52) U.S. Cl. 429/34; 429/30

(57) ABSTRACT

The present invention provides a fuel cell device capable of suppressing or filtering moisture discharge such as the generated water by the reaction, and an electronic appliance on which such a fuel cell device is mounted. This is achieved by comprising a water tank 18 for recovering water separated from the exhaust air of a fuel cell 4 that generates electricity by using a fuel; and a path (recovery pipe 16) for discharging the exhaust air by introducing to above the surface of the water stored in the water tank. The device further comprises a water absorption part 64 for absorbing moisture in the exhaust air having passed through the water tank.

### BACKGROUND OF THE INVENTION

1. Field of the Invention

The present invention relates to a fuel cell device using a liquid fuel or the like, and more specifically to a fuel cell device with improved convenience of suppressing moisture discharge or the like and an electronic appliance mounting such a device.

2. Description of the Related Art

A fuel cell is constructed such that a polyelectrolyte membrane is disposed as a proton-conducting or electron-conducting material; a fuel electrode is disposed on one side of the electrolyte membrane; and an oxidizer electrode is arranged opposite to the fuel electrode, wherein a liquid fuel such as a methanol aqueous solution including hydrogen component is supplied to the fuel electrode whereas air including oxygen component is supplied to the oxidizer electrode. The electrolyte membrane allows hydrogen protons in the liquid fuel at the fuel electrode side to pass through to couple to oxygen in the air at the oxidizer electrode side. Since electrons remaining in the hydrogen in the liquid fuel are extracted to outside as electricity by this coupling, this functions as a cell.

In such a fuel cell, when methanol is used as a liquid fuel, water (steam vapors) is generated at the oxidizer electrode side by the reaction of hydrogen and oxygen, and carbon dioxide (CO₂) is generated at the fuel electrode side by decomposition of methanol. In this processing, if electricity is generated through such an ideal chemical reaction wherein 1 mole of methanol and 1 mole of water are consumed at the fuel electrode whereas 1 mole of oxygen is consumed at the oxidizer electrode, then 3 moles of water are generated at the oxidizer electrode side and 1 mole of carbon dioxide is generated at the fuel electrode side.

In a fuel cell device comprising such a fuel cell, a fuel tank is provided for supplying a liquid fuel to the fuel cell. Although using a high-concentration fuel can reduce the size of the fuel tank, a high performance is required for the electrolyte membrane. If the electrolyte membrane has a low performance, using a high-concentration fuel increases the amount of fuel consumption and worsens the efficiency of electricity generation. Moreover, by using a high-concentration fuel, there arises a possibility of shortening lives of component materials of the fuel cell, for example, the electrolyte membrane, catalyst materials such as platinum supported carbon, and adhesive materials to bond them. With all things considered, it is recommended to use a fuel having about 1 mol concentration by keeping a high-concentration fuel in the fuel tank and by diluting the fuel to about 1 mol concentration. In this case, diluting the high-concentration fuel requires water as a diluent and a diluted fuel tank to store the fuel diluted with water. Since driving the fuel cell consumes the fuel, a water level sensor monitors a water level of the diluted fuel tank as well as a concentration sensor monitors a concentration of the fuel, and based on them, replenishing volumes of water and fuel are controlled.

Among patent documents related to such fuel cell devices, there is one that uses methanol as fuel and discharges moisture in exhaust gases after the reaction through condensation and separation (e.g., Japanese Published Examined Application No. H06(1994)-22150); one that removes moisture inside the fuel cell after its operation is stopped (e.g., Japanese Patent Application Laid-Open Publication No. 2002-208422); and one that uses a mechanism in which the electrolyte membrane and the liquid fuel are used, and substances containing water discharged from the fuel cell is put into gas-liquid contacting (e.g., Japanese Patent Application Laid-Open Publication No. 2003-297401).

By the way, in general, exhaust air and generated water by the reaction produced from the oxidizer electrode of the fuel cell are discharged to outside air after gas-liquid separation. The above-described Patent Application Laid-Open Publication No. 2003-297401 uses a configuration in which a water recovery tank is disposed to store water and a return pipe is disposed below the surface of the water in the recovery tank so that the exhaust air and the generated water by the reaction can be returned into the water of the water recovery tank. According to such a configuration, although it is possible to recover the generated water by the reaction and impurities contained in the exhaust air into the water recovery tank, there is a possibility that the exhaust air introduced into the water recovery tank rises up as bubbles in the water of the water recovery tank to cause vaporization of the water. If the amount of airflow of the fuel cell device is large, the exhaust air exposed to the moisture in the water recovery tank vaporizes the water and carries to the outside air together with the exhaust air. Furthermore, since the vaporized moisture has been absorbed in the exhaust air so that disposing a gas-liquid separation membrane is not helpful to separate it as moisture.

If such exhaust air containing moisture is carried to outside the fuel cell device, there arises inconvenience of dew condensation by a temperature difference of the outside air or of the outer wall of adjoining devices. Leaving such dew condensation as it is causes troubles in the adjoining devices and the like. Therefore, in order to prevent dew condensation, the generated water needs to be recovered. None of the above-described Published Examined Application No. H06(1994)-22150 and Patent Application Laid-Open Publication Nos. 2002-208422 and 2003-297401 discloses such issues at all, nor discloses or suggests any solutions for the issues.

### SUMMARY OF THE INVENTION

It is therefore an object of the present invention to suppress discharge of moisture such as the generated water by the reaction, regarding a fuel cell device discharging the exhaust air from the oxidizer electrode.

Another object of the present invention is to discharge moisture such as the generated water by the reaction after a filtration, regarding a fuel cell device discharging the exhaust air from the oxidizer electrode.

Still another object of the present invention is to provide an electronic appliance mounting a fuel cell device capable of suppressing discharge of moisture such as the generated water by the reaction.

To attain the above-described objects, according to a first aspect of the present invention there is provided a fuel cell device comprising a water tank recovering water separated from exhaust air of a fuel cell generating electricity by use of a fuel; and a path discharging the exhaust air by introducing to the water tank, wherein the path discharges the exhaust air by introducing to above the surface of the water stored in the water tank.

According to such a configuration, since the exhaust air discharged from the fuel cell is introduced into the water tank via the path and cooled down while passing the path, steam vapors condense. The moisture is introduced into the water tank along with the exhaust air, however, since the exhaust air is introduced into above the surface of the stored water so that the exhaust air never passes through the water in the water tank. That is, the water tank serves as gas-liquid separation. In addition, even if the exhaust air passes through the water tank, it does not pass through the water so that the passing air never carries the water in the water tank. As a result of this, the exhaust air with less moisture is discharged to outside the water tank.

To attain the above-described objects, this fuel cell device may further comprise a water absorption part disposed in the path at the downstream side of the water tank, absorbing moisture from the exhaust air passing thereat. According to such a configuration, since moisture in the exhaust air is absorbed by the water absorption part while passing therein, the exhaust air becomes low in humidity. Also cooling down of the exhaust air can be expected by passing through the water absorption part.

To attain the above-described objects, this fuel cell device may further comprise a gas-liquid separation part disposed in the path at the downstream side of the water tank, separating moisture from the exhaust air passing thereat. According to such a configuration, moisture in the exhaust air is removed by the gas-liquid separation part.

To attain the above-described objects, in this fuel cell device, the fuel cell may be comprised of an oxidizer electrode supplying air to one side of an electrolyte membrane and a fuel electrode supplying a fuel to the other side of the electrolyte membrane, the electrodes being disposed sandwiching the electrolyte membrane.

To attain the above-described objects, this fuel cell device may further comprise a diluted fuel tank storing a diluted fuel diluted with water, the diluted fuel tank being integrated into the water tank.

To attain the above-described objects, this fuel cell device may further comprise a diluted fuel tank storing a diluted fuel diluted with water, the diluted fuel tank being connected to the water tank storing the water via a pipeline.

To attain the above-described objects, this fuel cell device may further comprise a stabilization circuit extracting electricity output of the fuel cell after stabilization and a battery charged by receiving the output of the stabilization circuit.

To attain the above-described objects, this fuel cell device may further comprise a fuel tank storing a fuel; a diluted fuel tank storing a diluted fuel produced by diluting the fuel supplied from the fuel tank with the water supplied from the water tank; and an air supply part supplying the air to an oxidizer electrode of the fuel cell in which the oxidizer electrode and a fuel electrode are disposed sandwiching an electrolyte membrane.

To attain the above-described objects, in this fuel cell device, the water absorption part may be detachably attached to the fuel cell device.

To attain the above-described objects, in this fuel cell device, the electrolyte membrane may be a permeable membrane letting protons or electrons pass through.

To attain the above-described objects, this fuel cell device may further comprise a pump disposed in a fuel supply path connecting the fuel tank and the diluted fuel tank, the pump introducing the fuel from the fuel tank to the diluted fuel tank.

To attain the above-described objects, this fuel cell device may further comprise a pump disposed in a water supply path connecting the water tank and the diluted fuel tank, the pump introducing the water from the water tank to the diluted fuel tank.

To attain the above-described objects, this fuel cell device may further comprise a combined tank unit in which the fuel tank and the water absorption part are combined.

To attain the above-described objects, this fuel cell device may further comprise a combined tank unit in which the water tank and the diluted fuel tank are combined.

To attain the above-described objects, according to a second aspect of the present invention there is provided a fuel cell device comprising a water tank recovering water separated from the exhaust air of a fuel cell generating electricity by use of a fuel; a path introducing the exhaust air to below the surface of the water stored in the water tank; and a water absorption part disposed in the path at the downstream side of the water tank, absorbing moisture from the exhaust air passing thereat. According to such a configuration, since it is equipped with the water absorption part, moisture can be also removed in the case where the exhaust air is discharged by being introduced into the water of the water tank. By passing through the water, impurities in the exhaust air can be recovered in the water.

To attain the above-described objects, according to a third aspect of the present invention there is provided an electronic appliance comprising a fuel cell device in its power source part, the fuel cell device including a water tank recovering water separated from the exhaust air of the fuel cell generating electricity by use of a fuel; and a path exhausting the exhaust air by introducing to the water tank. According to such a configuration, the amount of moisture discharged along with the exhaust air can be suppressed so that inconvenience caused by dew condensation can be avoided.

To attain the above-described objects, this electronic appliance may further comprise a water absorption part absorbing moisture from the exhaust air passing thereat, which is disposed in the path at the downstream side of the water tank, the path exhausting the exhaust air by introducing to either above or below the surface of the water stored in the water tank.

To attain the above-described objects, this electronic appliance may further comprise a stabilization circuit extracting electricity output of the fuel cell device after stabilization; and a battery to be charged by receiving the output of the stabilization circuit.

To attain the above-described objects, in this electronic appliance, a cabinet part of the fuel cell device may be disposed thereon, the cabinet part further comprising a fuel tank storing the fuel detachably attached thereto.

To attain the above-described objects, this electronic appliance may further comprise a window in the fuel tank, from which remaining amount of the fuel can be checked.

According to a fuel cell device of the present invention, the amount of moisture discharged along with the exhaust air can be suppressed so that dew condensation can be reduced.

According to an electronic appliance of the present invention, the amount of moisture discharged from the built-in fuel cell device is suppressed so that dew condensation can be reduced, and thus contributes to enhance its reliability.

Other objects, features and advantages of the present invention will become more apparent from the following detailed description of the embodiments with reference to the accompanying drawings.

### BRIEF DESCRIPTION OF THE DRAWINGS

FIG. 1 is a diagram showing a fuel cell device according to a first embodiment;

FIG. 2 is a diagram showing a configuration example of a fuel cell;

FIG. 3 is a flowchart showing a control processing;

FIG. 4 is a diagram showing a fuel cell device according to a second embodiment;

FIG. 5 is a diagram showing a configuration example of a water absorption part in a fuel cell device according to a third embodiment;

FIG. 6 is a diagram showing a combined fuel tank unit in which the fuel tank and a water absorption part are combined together;

FIG. 7 is a diagram showing a fuel cell device according to a fourth embodiment;

FIG. 8 is a block diagram showing a PC according to a fifth embodiment;

FIG. 9 is a diagram showing a combined tank unit of a fuel cell device according to a sixth embodiment;

FIG. 10 is a perspective view showing a configuration example of a combined tank unit;

FIG. 11 is a front view showing a combined tank unit;

FIG. 12 is a diagram showing a combined tank unit of a fuel cell device according to a seventh embodiment;

FIG. 13 is an exploded perspective view showing a PC according to an eighth embodiment;

FIG. 14 is a perspective view showing a combined fuel tank unit;

FIG. 15 is a front view showing a combined fuel tank unit;

FIG. 16 is a plan view showing a combined fuel tank unit;

FIG. 17 is an exploded perspective view showing a PDA according to a ninth embodiment;

FIG. 18 is an exploded perspective view showing, a mobile phone according to a tenth embodiment; and

FIG. 19 is an exploded perspective view showing a lighting fixture according to other embodiments.

### DESCRIPTION OF THE PREFERRED EMBODIMENTS

### First Embodiment

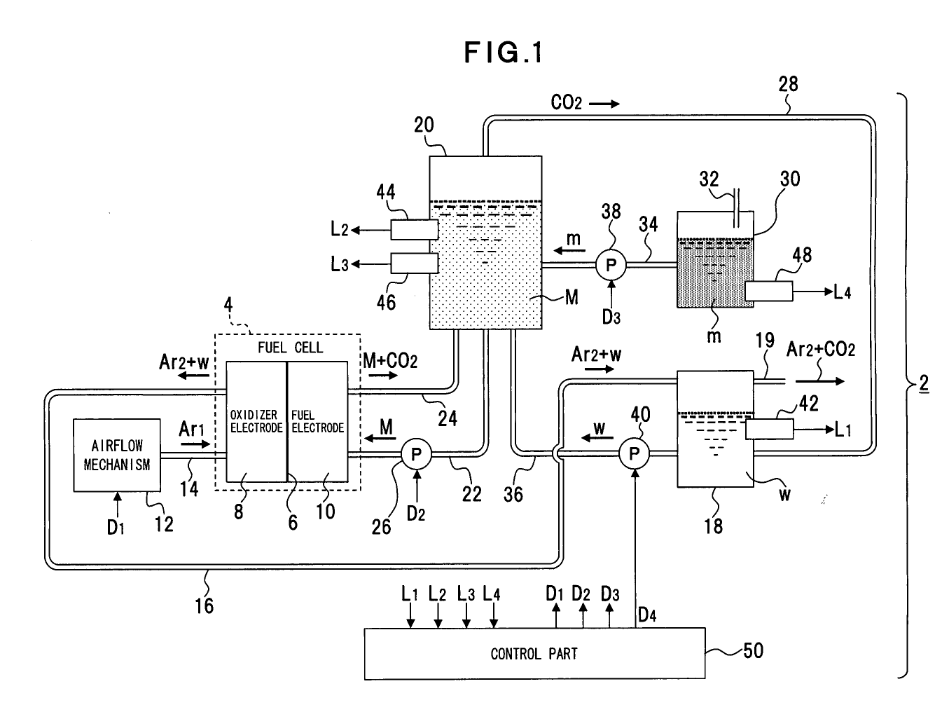

A first embodiment of the present invention will be described with reference to FIG. 1. FIG. 1 is a diagram showing a fuel cell device according to a first embodiment.

This fuel cell device 2 includes a fuel cell 4 that generates electricity by using a fuel. In this fuel cell 4, an electrolyte membrane 6, an oxidizer electrode 8, and a fuel electrode 10 are disposed. The oxidizer electrode 8 and the fuel electrode 10 are disposed sandwiching the electrolyte membrane 6, and the oxidizer electrode 8 supplies air containing oxygen component to one surface of the electrolyte membrane 6, while the fuel electrode 10 supplies a liquid fuel containing hydrogen component, for example, methanol aqueous solution or the like as a fuel to the other surface of the electrolyte membrane 6. The electrolyte membrane 6 is a permeable membrane formed by a proton-conductive or electron-conductive material, and is comprised of a polyelectrolyte membrane such as a proton-conductive solid polymer membrane composed of a perfluorsulfonic acid “Nafion” (registered tradename of Du Pont) or the like. Therefore, hydrogen protons in the liquid fuel at the fuel electrode 10 side pass through the electrolyte membrane 6, and these hydrogen protons are coupled to oxygen in the air supplied from the oxidizer electrode 8 side. As a result of this coupling, electrons remaining in the hydrogen in the liquid fuel are extracted to outside as electricity, and this electricity generation functions as a cell.

To the oxidizer electrode 8, an airflow mechanism 12 as an air supply part is attached via an air supply pipe 14, and an air Ar1 containing oxygen O₂ is supplied thereto by the drive of the airflow mechanism 12. The fuel cell 4 consumes oxygen by the reaction and yields water “w” that is the generated water by the reaction as steam vapors (hereinafter simply referenced as “water”). Since this water w has been vaporized so that it is discharged along with an excessive air Ar2 (i.e., exhaust air) from the oxidizer electrode 8 side. This excessive air Ar2 is mixed with carbon dioxide CO₂ resulting from the reaction. These excessive air Ar2 and water w are introduced into above the surface of water w stored in a water tank 18 via a recovery pipe 16 as a path, for example. An exhaust pipe 19 for discharging the excessive air Ar2 is provided on the water tank 18. The heat of the excessive air Ar2 is cooled down while passing through the recovery pipe 16, and during this cooling down process, it becomes condensed as the water w and recovered into the water tank 18. In this case, the water tank 18 serves as a water recovery tank in a sense that it recovers the water w, however, the water w that has been stored will be used as diluting water for the liquid fuel so that it also serves as a diluting water tank.

By the way, in this fuel cell 4, when methanol is used as liquid fuel, the water w (steam vapors) is generated at the oxidizer electrode 8 side by the reaction of hydrogen and oxygen via a proton catalyst of the electrolyte membrane 6, and carbon dioxide CO₂ is generated as bubbles at the fuel electrode 10 side by decomposition of methanol. For instance, if an electricity generation through such an ideal chemical reaction is performed wherein 1 mole of methanol and 1 mole of water are consumed at the fuel electrode 10 side whereas 1 mole of oxygen is consumed at the oxidizer electrode 8 side, then after the electricity generation, about 3 moles of water are generated at the oxidizer electrode 8 side and about 1 mole of carbon dioxide is generated at the fuel electrode 10 side.

To the fuel electrode 10, a diluted fuel tank 20 is attached via an outgoing pipe 22 and a return pipe 24, and a circulation pump 26 is disposed in the outgoing pipe 22. A diluted fuel M stored in the diluted fuel tank 20 circulates by the drive of the circulation pump 26. From the fuel electrode 10, unreacted fuel M and carbon dioxide CO₂ flow into the diluted fuel tank 20 via the return pipe 24, thereby the unreacted fuel M is mixed in the diluted fuel M, whereas the carbon dioxide is separated from the unreacted fuel M and introduced into the water w in the water tank 18 from the diluted fuel tank 20 via the exhaust pipe 28 as a path, for example. In this case, even if the exhaust air Ar2 enters into the return pipe 24, the exhaust air is separated from the unreacted fuel M in the same way and introduced into the water tank 18 via the exhaust pipe 28.

To the diluted fuel tank 20, a liquid fuel tank 30 is connected via a fuel supply pipe 34 as well as the water tank 18 is connected via a water supply pipe 36. The fuel supply pipe 34 is provided with a fuel pump 38 and the water supplypipe 36 is providedwithawater pump 40. On the liquid fuel tank 30, an exhaust outlet 32 is formed, and for example, methanol is stored as the liquid fuel m. This liquid fuel m is supplied to the diluted fuel tank 20 by the drive of the fuel pump 38. And the water w in the water tank 18 is supplied to the diluted fuel tank 20 by the drive of the water pump 40. As aresult, the diluted fuel M (=m+w) is produced.

A level sensor 42 is disposed in the water tank 18; a concentration sensor 44 and a level sensor 46 are disposed in the diluted fuel tank 20; and a level sensor 48 is disposed in the liquid fuel tank 30. The level sensor 42 detects a water level of the water tank 18 and issues a detection signal L1; the concentration sensor 44 detects a fuel concentration of the diluted fuel M and issues a detection signal L2; the level sensor 46 detects a level of the diluted fuel M and issues a detection signal L3; and the level sensor 48 detects a level of the liquid fuel m and issues a detection signal L4, and these detection signals L1 to L4 are added to a control part 50 as control information. The control part 50 issues driving signals D1, D2, D3, D4 and the like, whereby a fan motor at the airflow mechanism 12 is driven by the driving signal D1; the circulation pump 26 is driven by D2; the fuel pump 38 is driven by D3; and the water pump 40 is driven by D4. That is, the control part 50 consists of microprocessors and the like, and executes through its control programs various kinds of controls such as fuel supply control and airflow control to the fuel cell 4 and concentration control of the diluted fuel M.

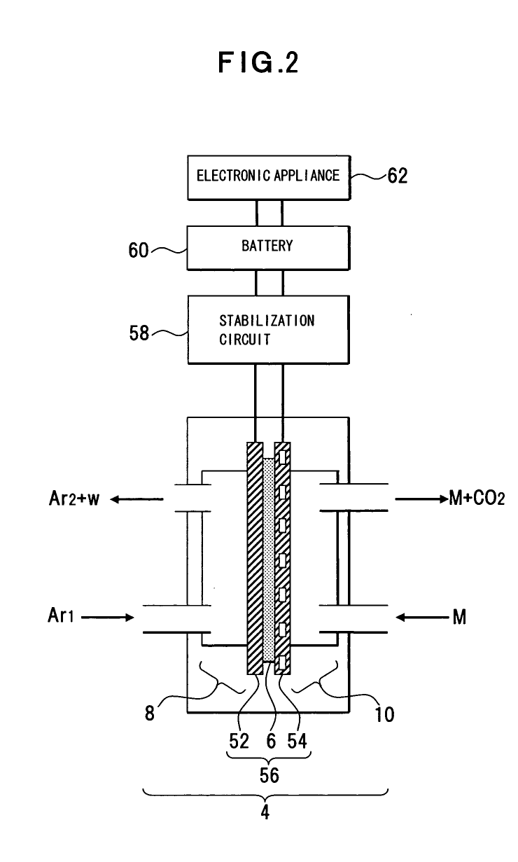

The fuel cell 4 in this fuel cell device 2 and its extraction of output will be described with reference to FIG. 2. FIG. 2 is a diagram showing a configuration outline of the fuel cell 4 and its output part. In FIG. 2, the same symbols are assigned to parts identical to those of the fuel cell device 2 shown in FIG. 1.

An oxidizer electrode 52 is disposed at the oxidizer electrode 8, and a fuel electrode 54 is disposed at the fuel electrode 10. The electrolyte membrane 6 is disposed sandwiching the oxidizer electrode 52 and the fuel electrode 54. In this fuel cell 4, a layered product formed of the electrolyte membrane 6, the oxidizer electrode 52, and the fuel electrode 54 comprises an electrolyte plate 56.

A battery 60, for example, is connected to the oxidizer electrode 52 and the fuel electrode 54 as a secondary cell via a stabilization circuit 58. The electricity generated at the oxide electrode 52 and the fuel electrode 54 is stored in the battery 60 after having been stabilized by the stabilization circuit 58. The output of this battery 60 is applied to an electronic appliance 62 that uses the fuel cell device 2 as its power source. This electronic appliance 62 may include, for example, a personal computer (PC), a mobile phone, or the like.

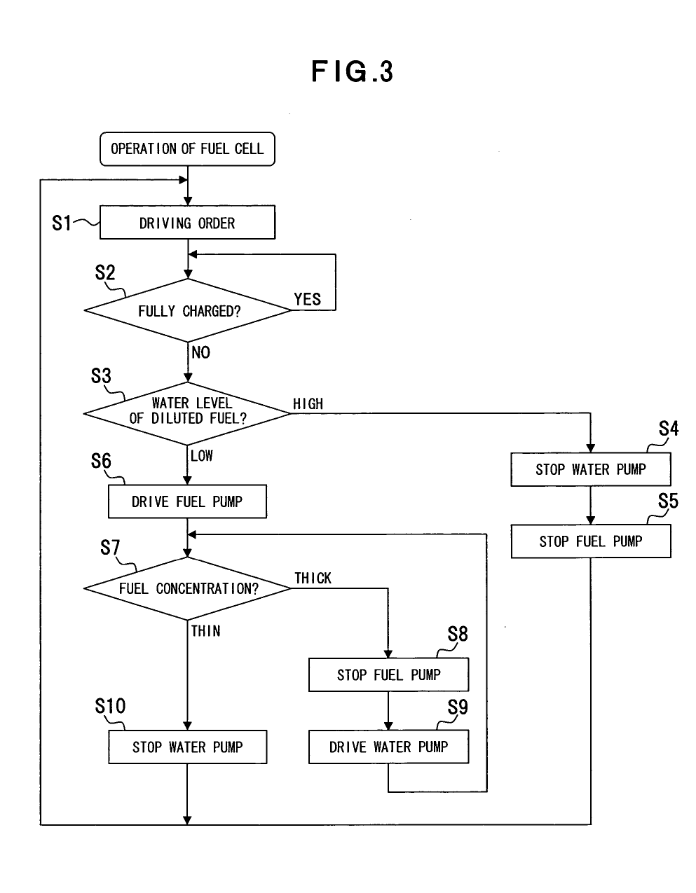

Next, operations of this fuel cell device 2 will be described with reference to FIG. 3. FIG. 3 is a flowchart showing a control processing executed by the control part 50.

With an issue of driving order to the control part 50 (step S1), the processing enters into operation state. Under this operation state, the airflow mechanism 12, the circulation pump 26, the fuel pump 38, and the water pump 40 are driven. When switched to the operation state, it is judged whether or not the battery 60 is fully charged (step S2). This fully charged condition can be judged by a level of charging voltage of the battery 60, and if it is fully charged, the processing waits for further operation in this step S2.

If the battery 60 is not fully charged, driving of the fuel cell device 2 continues and a level of the diluted fuel M (liquid level) is judged by the detection signal L3 from the level sensor 46 (step S3). If the level of this diluted fuel M is high, the water pump 40 is stopped (step S4), and the fuel pump 38 is stopped (step S5), and then the processing returns to step S1. That is, when the level of the diluted fuel M is high, the operation of the fuel cell 4 can continue so that there is no need to produce and add the diluted fuel M.

If the level of the diluted fuel M is low, the fuel pump 38 is driven (step S6); the liquid fuel m is supplied to the diluted fuel tank 20 and the fuel concentration of the diluted fuel M is judged by the detection signal L2 from the concentration sensor 44 (step S7); and if the concentration is high (thick), the fuel pump 38 is stopped (step S8); the water pump 40 is driven (step S9); the water w is supplied from the water tank 18 to the diluted fuel tank 20; and the processing returns to step S7.

The fuel concentration of the diluted fuel M to which the water w is supplied is monitored by the detection signal L2 from the concentration sensor 44 (step S7), and if the fuel concentration becomes low (thin), the water pump 40 is stopped (step S10) and the processing returns to step S1.

The generation of electricity continues by repeating such control operations, and the battery 60 is charged by the output of the fuel cell 4, and when the battery reaches a fully charged condition, driving of the fuel cell device 2 is stopped.

By the way, in this fuel cell device 2, as described above, when methanol is used as the liquid fuel m, the generation of electricity through an ideal chemical reaction is achieved, and after the generation of electricity, approximately 3 moles of water are generated at the oxidizer electrode 8 side whereas about 1 mole of carbon dioxide is generated at the fuel electrode 10 side. Further, in the fuel cell 4, using a high-concentration fuel increases the amount of methanol per unit of the electrolyte membrane 6 so that an electromotive force can be improved as well as the size of the liquid fuel tank 30 can be reduced. However, a counter-electromotive force tends to be generated, therefore, considering a problem of life of the electrolyte membrane 6, it is desirable to supply the diluted fuel M of 1 mole concentration to the fuel cell 4. As a consequence, by the above-described control, the liquid fuel m of high-concentration is supplied from the liquid fuel tank 30 to the diluted fuel tank 20; the liquid fuel m is diluted with the water w supplied to the diluted fuel tank 20 from the water tank 18; and the diluted fuel M in a proper concentration is circulated to the fuel electrode 10 by the circulation pump 26.

Moreover, in this fuel cell device 2, recycling of steam vapors is achieved by returning vapors to the diluted fuel tank 20 from the oxidizer electrode 8 to use as diluting water for the liquid fuel m. The amount of steam vapors (amount of water) generated at the oxidizer electrode 8 is large, and these steam vapors are recovered into the water tank 18 via the recovery pipe 16 and then supplied to the diluted fuel tank 20.

In this case, temperature of the water tank 18 is low in comparison with that of the fuel cell 4, and there is a difference between the temperatures of the fuel cell 4 and the water tank 18, and by heat release of the recovery pipe 16 flowing steam vapors, the steam vapors are condensed to be recovered as the water w in the water tank 18 side. That is, the recovered water w is recycled by mixing into the water w in the water tank 18 side so that an effective use of the water w can be achieved. In addition, the carbon dioxide CO₂ generated at the fuel electrode 10 side as well as the diluted fuel M unconsumed at the fuel electrode 10 (unreacted fuel) is recovered into the diluted fuel tank 20 for recycling via the return pipe 24 as a circulation path.

Also in this fuel cell device 2, the exhaust air Ar2 from the oxidizer electrode 8 of the fuel cell 4 and the water w have been introduced into above the surface of the water w in the water tank 18 via the recovery pipe 16, so that the water w and impurities in the exhaust air Ar2 can be recovered into the water tank 18 without passing through the water w in the water tank 18. It has been already described that the water w (steam vapors) condenses by being cooled down while passing through the recovery pipe 16 to be recovered into the water w in the water tank 18. Furthermore, for the exhaust air Ar2 passing through the water tank 18, gas-liquid separation is performed well and the exhaust air Ar2 is discharged without moisture into the exhaust pipe 19 from the water tank 18.

Such a fuel cell device 2 requires anairflow amount of 0.5 L/min or more in order to generate electricity of approximately 10 W or more, and the size of the water tank 18 for this amount of electricity generation is relatively compact. However, depending on attachable forms of the recovery pipe 16, the efficiency of water recovery may be degraded because returning the exhaust air Ar2 into the water tank 18 may cause the water w in the water tank 18 to be massively absorbed into the exhaust air by the airflow, then vaporized and discharged to outside. In contrast to this, since in this embodiment, the exhaust air Ar2 and the water w are introduced into above the surface of the water in the water tank 18 via the recovery pipe 16 in order to recover the water w, the efficiency of water recovery can be substantially improved.

### Second Embodiment

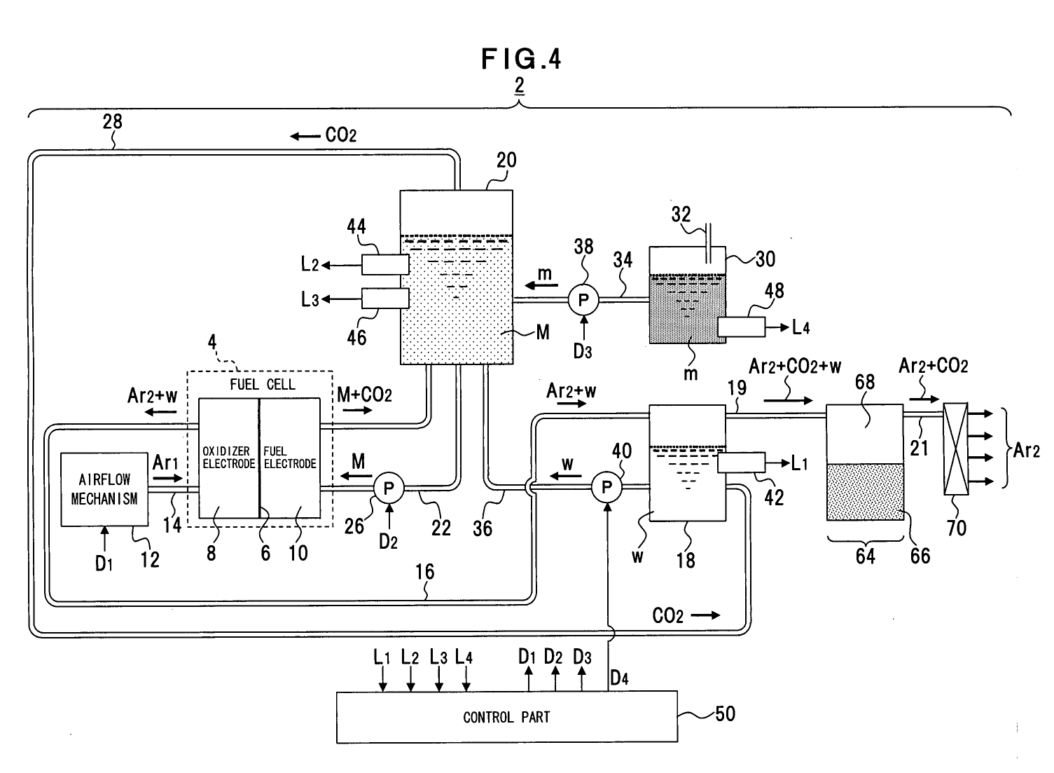

A second embodiment of the present invention will be described with reference to FIG. 4. FIG. 4 is a diagram of a fuel cell device according to a second embodiment. In FIG. 4, the same symbols are assigned to parts identical to those of the first embodiment (FIG. 1).

This fuel cell device 2 further comprises a water absorption part 64 disposed in midstream of the exhaust pipe 19 at the downstream side of the water tank 18. This water absorption part 64 is filled with a water-absorbing material 66, which dries the exhaust air Ar2 and carbon dioxide CO₂ by absorbing moistures in the exhaust air Ar2, the carbon dioxide, and uncollected water w that flow into the water absorption part 64 from the exhaust pipe 19. As the water-absorbing material 66, for example, silica gel or the like is used as a drying or moisture-absorbing agent. Silica gel is, as is well known, a transparent glassy state solid where amorphous hydrated silica is partially dehydrated. Sending the carbon dioxide CO₂ and the uncollected water w to the water absorption part 64 is conducted by a pressure power of the air Ar1 applied from the above-described airflow mechanism 12.

In addition, in this embodiment, the water absorption part 64 is provided with a reservoir space 68 where the water w flown out of the water tank 18 can be stored. This reservoir space 68 has enough capacity to store the water w overflowed from the water tank 18.

Moreover, in this embodiment, a filter part 70 as a gas-liquid separation part is disposed at the downstream side of the water absorption part 64. Into this filter part 70, the exhaust air Ar2 and carbon dioxide CO₂ or the like are introduced from the water absorption part 64 via an exhaust pipe 21, and if the uncollected water w exists, it flows into the filter part 70 along with the exhaust air Ar2. The filter part 70 is comprised of a gas-liquid separation membrane or the like separating gas from liquid, and through this filter part 70, the exhaust air Ar2 or the like is discharged to the outside air. Other configurations are the same as the first embodiment, so that the description is omitted.

Although most of the exhaust air Ar2, carbon dioxide CO₂, and the water w that have passed through the water tank 18 are recovered into the water tank 18, the exhaust air Ar2 and carbon dioxide CO₂ have yet to be dried up. Therefore, according to this configuration, the exhaust air Ar2 and carbon dioxide having passed through the water tank 18 are introduced into the water absorption part 64 via the exhaust pipe 19, and moisture remaining in the exhaust air Ar2 and carbon dioxide CO₂ are absorbed thereat by the water-absorbing material 66, and then discharged to the outside air through the filter part 70 via the exhaust pipe 21. The water absorption part 64 can dry the exhaust air Ar2 and carbon dioxide enough to turn into dry air. Furthermore, since the filter part 70 is comprised of a gas-liquid separation membrane or the like, and although this gas-liquid separation membrane cannot remove moisture absorbed in gases, it has a high capability of removing dewdrops. Therefore, if dewdrops remain in the exhaust air even after having passed through the absorption part 64, the dewdrops can be removed through the filter. Consequently, even if the temperature of the exhaust air is higher than that of the outside air, dry air is discharged so that dew condensation can be significantly reduced.

In such a fuel cell device 2, the temperature of the exhaust air of the fuel cell 4 is much higher than that of the outside air, and although the temperature of the exhaust air is reduced by temperature difference in the process of passing through the recovery pipe 16 to reach the water tank 18, yet there exists a difference of 10 degrees or more compared with the temperature of outside air. Because of this, dew condensation is predictable when the exhaust air Ar2 is discharged from the fuel cell 4 as it is, however, in the fuel cell device 2 according to the above-described embodiment, owing to the disposition of the water absorption part 64, and further more, owing to the disposition of the filter part 70, discharge as dry air is made possible and accordingly dew condensation can be surely prevented.

Further, the water w overflowed from the water tank 18 for some reason such as a tilt of the cabinet of the fuel cell device 2 is recovered into the reservoir space 68 in the water absorption part 64, so that water drain to outside can be prevented, and thus water leak accidents and others can be prevented.

### Third Embodiment

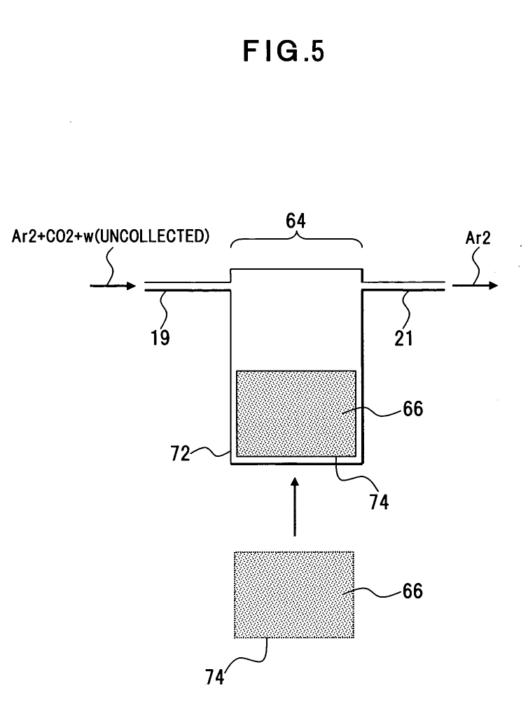

A third embodiment of the present invention will be described with reference to FIG. 5. FIG. 5 is a diagram showing the water absorption part 64 of the fuel cell device 2. In FIG. 5, the same symbols are assigned to parts identical to those of the second embodiment (FIG. 4).

The water absorption part 64 may further comprise a sealed container part 72 capable of storing the water w and a water absorption unit 74 that is attachable/detachable to the container part 72. The water absorption unit 74 is formed of the above-described water absorbing material 66.

According to such a configuration, capability to absorb water in the water absorption part 64 can be recovered by replacing the water absorption unit 74 according to reduction in its moisture absorbing power.

Furthermore, the water absorbing material 66 may be replaced by either detaching the material itself or by replacing the water absorption part 64 in which the water absorbing material 66 is filled as a replacement unit (FIG. 4).

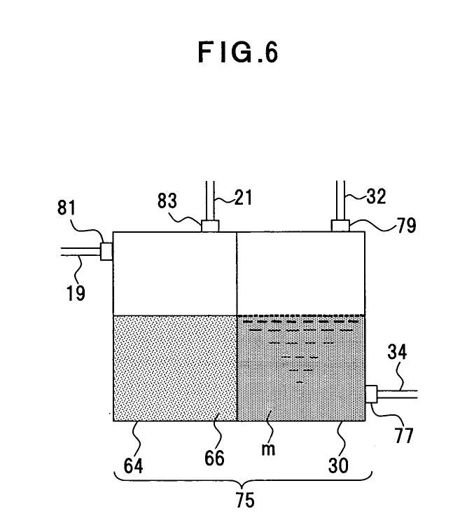

Moreover, the water absorption part 64, for example, may be configured as a combined fuel tank unit 75 by combining the liquid fuel tank 30 together, as shown in FIG. 6. In this combined fuel tank unit 75, a port 77 connecting to a fuel supply pipe 34 and a port 79 connecting to an exhaust outlet 32 are formed on the liquid fuel tank 30 side, whereas a port 81 connecting to an exhaust pipe 19 and a port 83 connecting to an exhaust pipe 21 are formed on the water absorption part 64 side. According to such a configuration, by providing commonality and removability among components that use consumables such as the liquid fuel m and the water-absorbing material 66 as constituent materials, replacement of these components can be simplified. Further, by combining the water absorption part 64 with the filter part 70 or the like, replacement can be simplified as well by providing commonality and removability among components that use consumables as constituent materials. According to such a configuration, convenience of the fuel cell device 2 can be enhanced.

### Fourth Embodiment

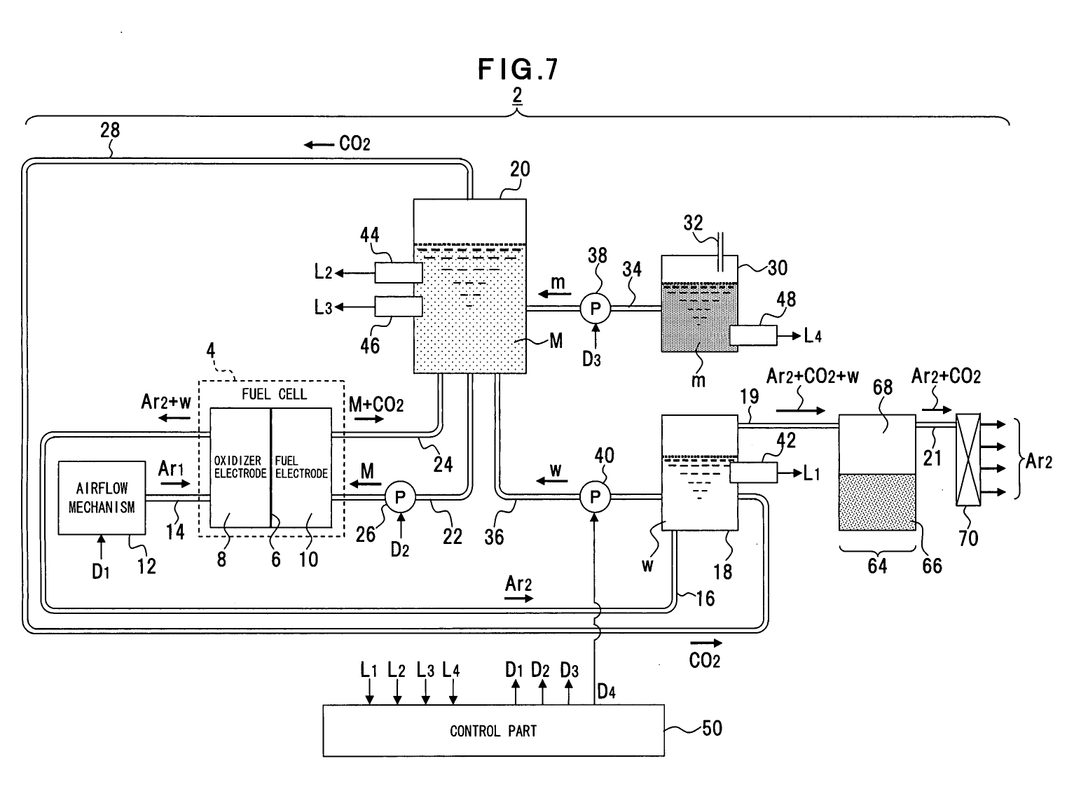

A fourth embodiment of the present invention will be described with reference to FIG. 7. FIG. 7 is a diagram showing the fuel cell device 2 according to a fourth embodiment. In FIG. 7, the same symbols are assigned to parts identical to those of the second embodiment (FIG. 4).

The second embodiment is constructed such that moisture is recovered by introducing the exhaust air Ar2 from the oxidizer electrode 8 of the fuel cell 4 into above the surface of the water w in the water tank 18, however, this fourth embodiment is constructed such that the exhaust air is introduced into the water w in the water tank 18.

It has been already described that the exhaust air Ar2 introduced into the water w vaporizes the moisture to outflow from the exhaust pipe 19 side. However, in this embodiment, the water absorption part 64 is disposed so that the water absorbing effect at the water absorption part 64 can be obtained, and the same effect as in the second embodiment can be expected. Further, even if dewdrops remain in the exhaust air, removal at the filter part 70 can be expected.

As described above, an airflow amount of 0.5 L/min or more is required in order to generate electricity of approximately 10 W or more, and the size of the water tank 18 for this amount of electricity generation is relatively compact. However depending on attachable forms of the recovery pipe 16, the efficiency of water recovery may be degraded because returning the exhaust air Ar2 into the water tank 18 may cause the water w in the water tank 18 to be massively absorbed into the exhaust air by the airflow, then vaporized and discharged to outside. Yet such an inconvenience can be avoided in electricity generation of less than 10 W.

### Fifth Embodiment

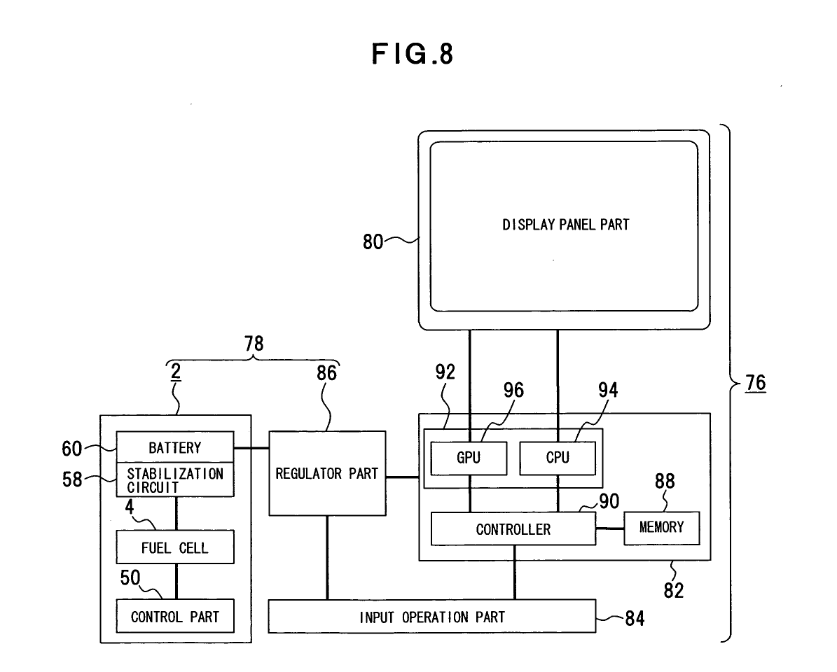

A fifth embodiment of the present invention will be described with reference to FIG. 8. FIG. 8 is a diagram showing a personal computer (PC) on which a fuel cell device 2 is mounted. In FIG. 8, the same symbols are assigned to parts identical to those of the first embodiment (FIGS. 1, 2).

In this embodiment, a PC 76 includes the fuel cell device 2 in a power source part 78. The fuel cell device 2, as described above, is equipped with the fuel cell 4, the control part 50, and the like. The fuel cell device 2 of this embodiment has a built-in stabilization circuit 58 and battery 60 as a secondary battery. Furthermore, the PC 76 includes a display panel part 80, a circuit board 82, an input operation part 84, a regulator part 86, and the like. The input operation part 84 is comprised of a mouse, a keyboard, and the like. Further, various memories 88, a controller 90, a motherboard 92, or the like are mounted on the circuit board 82, and a CPU (Central Processing Unit) 94, a GPU (Graphic Processing Unit) 96, or the like are mounted on the motherboard 92. The display at the display panel part 80 is controlled by the GPU 96.

According to such a configuration, the electricity generated at the fuel cell 4 is added to the battery 60 after having been stabilized by the stabilization circuit 58, and the battery 60 is charged therewith. The output of this battery 60 is supplied to the circuit board 82, the input operation part 84, and the display panel part 80, after having been converted into a predetermined voltage by the regulator part 86.

In the PC 76 using such a fuel cell device 2 for its power source, its electricity supply continues for a long time by simply replacing such as fuel and water, instead of replacing batteries in conventional art, so that continuous processing operations are made possible and the PC 76 with enhanced convenience is realized.

### Sixth Embodiment

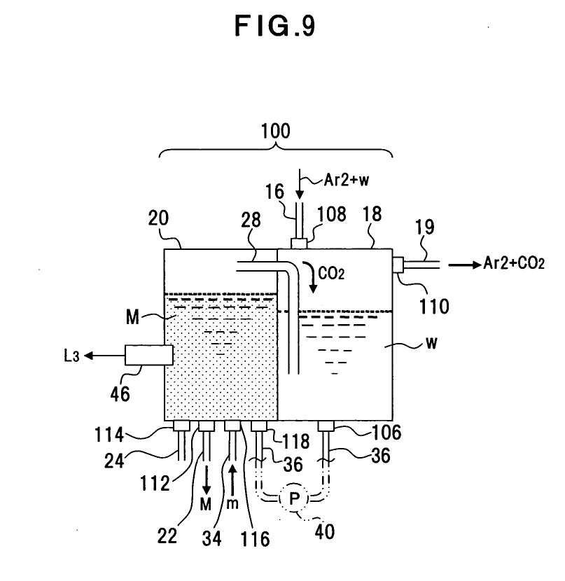

A sixth embodiment of the present invention will be described with reference to FIG. 9. FIG. 9 is a diagram showing a configuration example of a diluted fuel tank and a water tank used for the fuel cell device 2. In FIG. 9, the same symbols are assigned to parts identical to those of the first embodiment (FIGS. 1, 2).

In this embodiment, the water tank 18 and the diluted fuel tank 20 are combined together to form a combined tank unit 100 made of one cabinet part. In the combined tank unit 100, the above-described exhaust pipe 28 is disposed between the water tank 18 and the diluted fuel tank 20. The pipe 28 is arranged in such a way that its one end portion at the water tank 18 side is bent to enter into the water w in the water tank 18 whereas its other end portion at the diluted fuel tank 20 side is open to the space above the surface of the diluted fuel M. Disposing such an exhaust pipe 28 in the cabinet part can reduce the pipe routing, and thus contribute to simplifying the pipe arrangements as well as downsizing the fuel cell device 2.

The water tank 18 includes a port 106 disposed at the location that goes under the water and ports 108, 110 disposed at the location above the water surface, and there are the water supply pipe 36, the recovery pipe 16, and the exhaust pipe 19 that are connected to the ports 106, 108, and 110 respectively.

Further, the diluted fuel tank 20 includes ports 112, 114, 116, 118 formed thereon, and there are the outgoing pipe 22, the return pipe 24, the fuel supply pipe 34, and the water supply pipe 36 that are connected to the ports 112, 114, 116, and 118 respectively. To the ports 106, 118, the water pump 40 is disposed along with the water supply pipe 36.

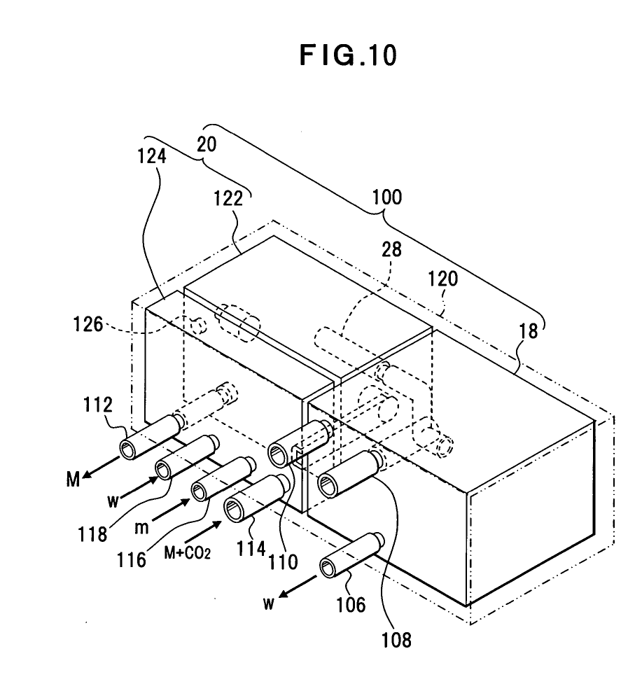

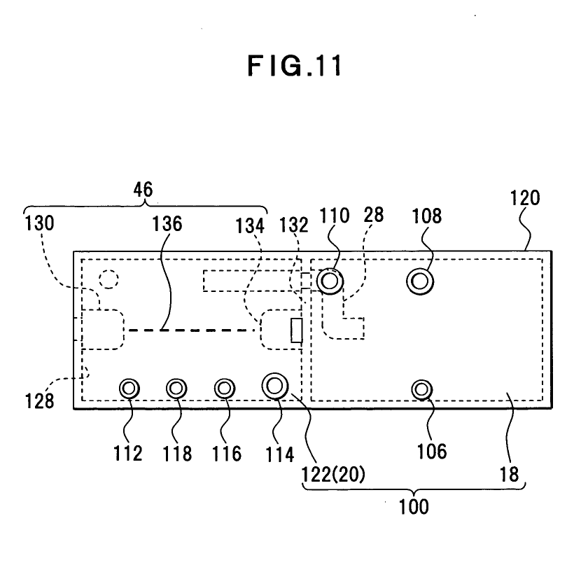

Next, a configuration example of the combined tank unit 100 will be described with reference to FIGS. 10, 11. FIG. 10 is a perspective view and FIG. 11 is a front view showing a configuration example of the combined tank unit 100. In FIGS. 10, 11, the same symbols are assigned to parts identical to those in FIG. 9.

This combined tank unit 100 forms the water tank 18 and the diluted fuel tank 20 in one cabinet part 120, and forms a main tank part 122 and a diluted part 124 in the diluted fuel tank 20. The diluted part 124 mainly produces a diluted fuel M by mixing the liquid fuel m with the water w. The main tank part 122 and the diluted part 124 are connected to each other via a communication part 126, and the diluted fuel M is stored in the main tank part 122. The diluted part 124 constitutes a sub tank part for the main tank part 122, and constitutes a mix part where the diluted fuel M and the like that are returned is mixed.

The port 112 is directly connected to the main tank part 122 side, and the other ports 114, 116, 118 are connected to the diluted part 124 side. Via the port 112, the diluted fuel M is extracted from the main tank part 122 side; via the port 114, the diluted fuel M and carbon dioxide CO₂ are returned from the fuel cell 4 to the diluted part 124; via the port 116, the liquid fuel m is supplied to the diluted part 124; and via the port 118, the water w is supplied to the diluted part 124.

According to such a configuration, in the diluted part 124, mixing of the liquid fuel m, the water w, and the diluted fuel M and carbon dioxide that are returned are conducted, and the diluted fuel M generated at the diluted fuel part 124 flows to the main tank part 122 via the communication part 126. Then, the diluted fuel M at the main tank part 122 is extracted via the port 112.

As shown in FIG. 11, a level sensor 46 detecting a level of the diluted fuel M is disposed in the main tank part 122 of the diluted fuel tank 20, and this level sensor 46 may be comprised of an optical sensor, for example. In this embodiment, an infrared emission part 130 is disposed on one side of the wall surface 128 of the main tank part 122, and a photoreceptor 134 is disposed on the wall surface 132 opposite to the wall surface 128. Between these wall surfaces 128, 132, the infrared emission part 130 faces the photoreceptor 134, and an infrared radiation track 136 between the two represents a water (liquid) detection level of the diluted fuel M.

According to this configuration, if the infrared radiation emitted from the infrared emission part 130 is received at the photoreceptor 134, with the reception, a detection signal representing that the diluted fuel M is lower than the predetermined level is obtained from the photoreceptor 134. If the diluted fuel M is higher than the predetermined level and thus hinders the reception of infrared radiation to the photoreceptor 134, a detection signal representing that the diluted fuel M is higher than the predetermined level is obtained from the photoreceptor 134. By such detection signals, it can be judged whether or not amount of the diluted fuel M is within the appropriate range.

In addition, regarding this combined tank unit 100, by forming in such a way that the volume of the area from the top of the water detection location in the diluted fuel tank 20 to the exhaust pipe 28 for discharging CO₂ to be equal to the amount of fuel contained in fuel cell 4 and moisture contained in the pipes between the fuel cell 4 and the diluted fuel tank 20 (the outgoing pipe 22 and the return pipe 24), the diluted fuel M can be saved and a leak from the fuel cell device 2 can be prevented.

### Seventh Embodiment

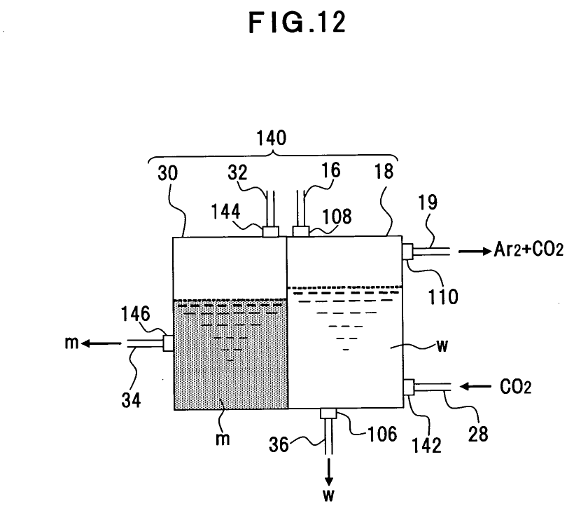

A seventh embodiment of the present invention will be described with reference to FIG. 12. FIG. 12 is a diagram showing a configuration example of a fuel tank and a water tank used in the fuel cell device 2. In FIG. 12, the same symbols are assigned to parts identical to those of first embodiment (FIGS. 1, 2) and sixth embodiment (FIG. 9, etc.).

In this embodiment, the water tank 18 and the liquid fuel tank 30 are combined together to form a combined tank unit 140 made of a single cabinet part. The water tank 18 is equipped with ports 106, 142 disposed at the location that goes under the water and ports 108, 110 disposed at the location above the water surface. There are the water supply pipe 36, the recovery pipe 16, the exhaust pipe 19, and the exhaust pipe 28 that are connected to the ports 106, 108, 110, and 142 respectively. Further, on the liquid fuel tank 30, ports 144, 146 are formed. The exhaust outlet 32 is formed on the port 144, and the fuel supply pipe 34 is connected to the port 146.

According to such a configuration, the liquid fuel m and the water w that are consumed can be replaced as a whole unit of the combined tank unit 140, so that the fuel cell device 2 with enhanced convenience can be provided. In this case, by setting the volume of the water tank 18 side large enough to such an extent that the water w stored in the water tank 18 would not exceed the consumption of the liquid fuel m at the fuel cell device 2, a shortage of the water w can be prevented.

### Eighth Embodiment

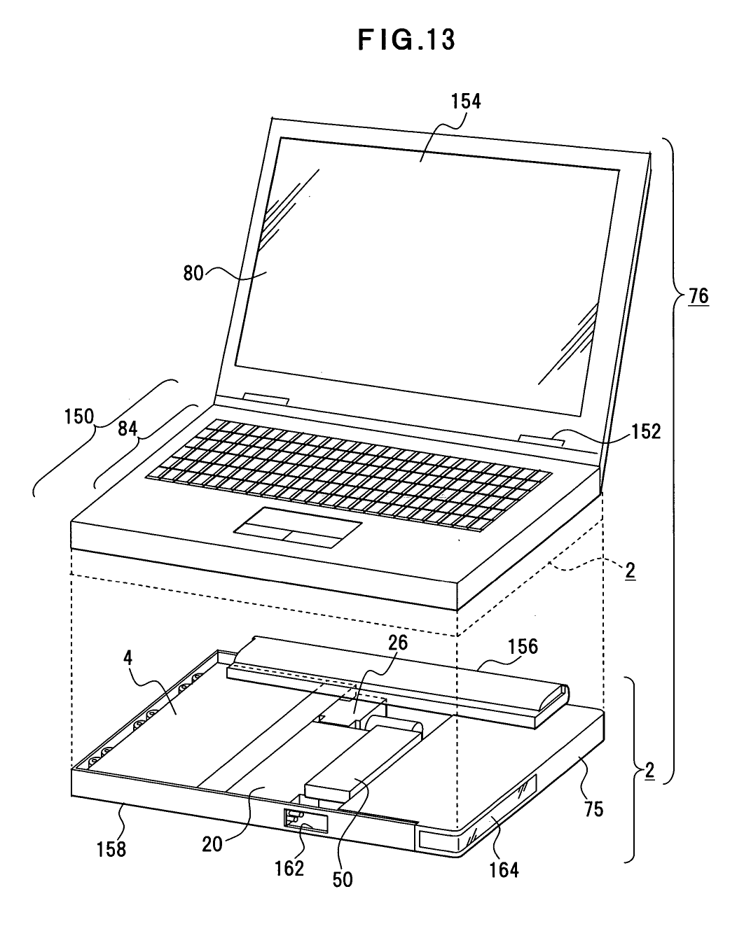

An eighth embodiment of the present invention will be described with reference to FIG. 13. FIG. 13 is an exploded perspective view showing a PC 76 (FIG. 8) in which the fuel cell device 2 is mounted. In FIG. 13, the same symbols are assigned to parts identical to those of the above-described embodiments (FIGS. 1, 8, etc.).

The PC 76 is an example of an electronic appliance in which the fuel cell device 2 is mounted, and in this embodiment, it is an example of a mobile personal computer. In this PC 76, a cabinet part 150 and a display panel part 80 are configured to be openable/closable via a hinge part 152, and in the cabinet part 150, an input operation part 84 including a plurality of keys and the like is disposed as well as the above-described circuit board 82 and the like. Further, in the display panel part 80, for example, an LCD (Liquid Crystal Display) 154 as a display part is disposed.

Further, on the rear part of the cabinet part 150 of this PC 76, the fuel cell device 2 is mounted along with a battery pack 156. For instance, the battery pack 156 is embedded inside the cabinet part 150 and the fuel cell device 2 is either fixed to be integrated into the rear part of the cabinet part 150 or detachably attached thereto. The battery pack 156 consists of a secondary cell such as the above-described battery 60 (FIG. 2), and is charged by the fuel cell device 2.

The fuel cell device 2 includes a cabinet part 158 corresponding to the cabinet part 150 of the PC 76, and in this cabinet part 158, the fuel cell 4, the airflow mechanism 12, the diluted fuel tank 20, the filter part 70 (FIG. 4), and the combined fuel tank unit 75 or the like are mounted. There is a vent part 162 formed on the cabinet part 158 to take in the outside air, and the vent part 162 is covered with a breathing waterproof sheet that is not shown.

There is a check window 164 formed on a side part of the combined fuel tank unit 75 of this embodiment in order to check remaining amount of the fuel inside. This combined fuel tank unit 75 can be detached/attached separately from the cabinet part 158. Thus, the remaining amount of the liquid fuel m can be checked easily from the check window 164, making replacements of the combined fuel tank unit 75 easier.

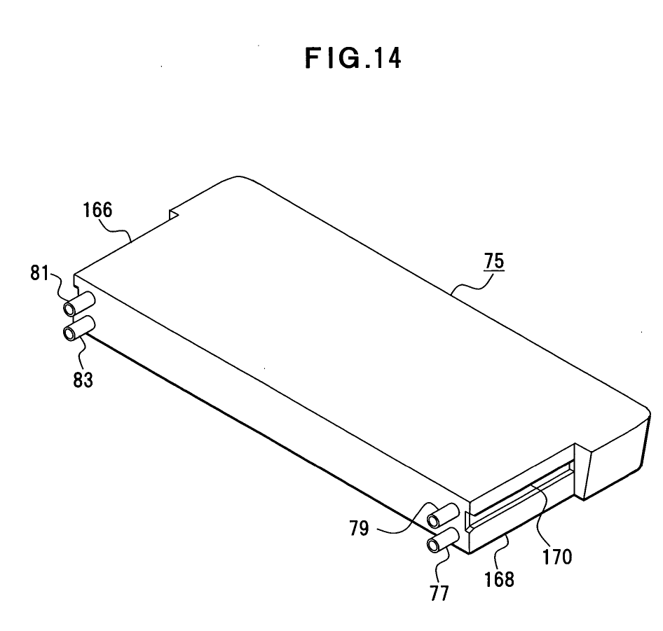

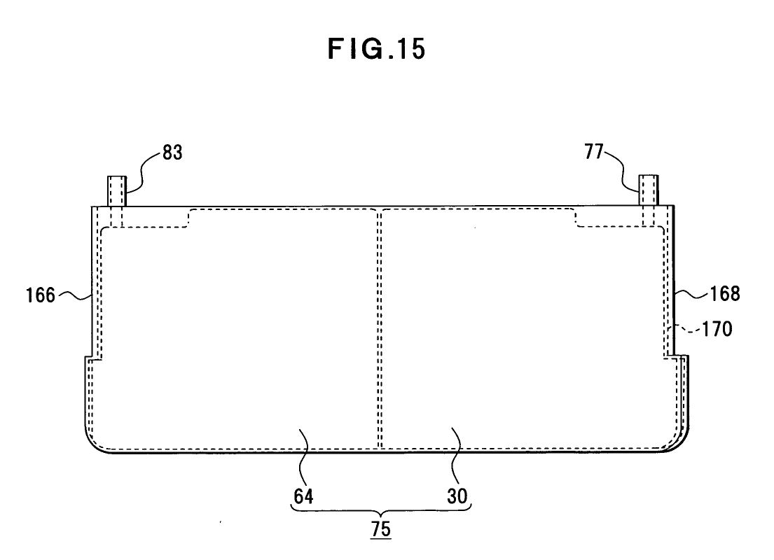

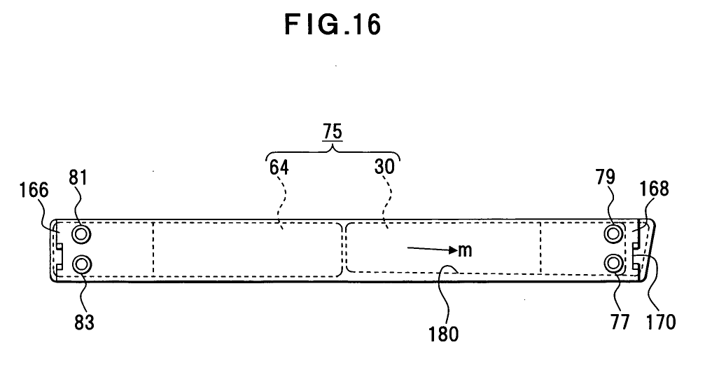

A configuration example of this combined fuel tank unit 75 (FIG. 6) will be described with reference to FIGS. 14 to 16. FIG. 14 is a perspective view, FIG. 15 is a front view, and FIG. 16 is a plan view showing a configuration example of the combined fuel tank unit 75.

As shown in FIG. 14, the combined fuel tank unit 75 is equipped with side parts 166, 168 that are formed to be smaller than the depth of the cabinet part 158, and on these side parts 166, 168, slide ditches 170 engaging the cabinet part 158 side are formed. On the front part of this combined fuel tank unit 75, the above-described ports 77, 79, 81, 83 (FIG. 6) are formed. Consequently, by conforming the slide ditches 170 to engage the cabinet part 158 side, ports 77, 79, 81, 83 are respectively conformed and combined to the pipe path mounted on the cabinet part 158.

This combined fuel tank unit 75 is constructed by combining the above-described liquid fuel tank 30 and the water absorption part 64 into a single cabinet, as shown in FIGS. 15, 16.

As shown in FIG. 16, by constructing a bottom part 180 of the liquid fuel tank 30 with a lean surface tilted toward the port 77 side, the liquid fuel m flows smoothly, which prevents residues in the tank and becomes economical.

According to such a configuration, not only configuration of the tanks can be simplified compared with a case in which the water absorption part 18 is disposed separately, but also the convenience of the fuel cell device 2 can be improved because replacement can be done only by replacing the combined fuel tank unit 75 without replacing the water absorption part 64 or the water-absorbing material 66 separately.

According to the PC 76 in which the above-described fuel cell device 2 is mounted, since operations such as replacing rechargeable batteries can be saved and a stable power supply for many hours can be obtained from the fuel cell device 2 simply by replacing the fuel, so that continuous operations can be realized and the convenience and mobility especially for a mobile PC can be further increased.

### Ninth Embodiment

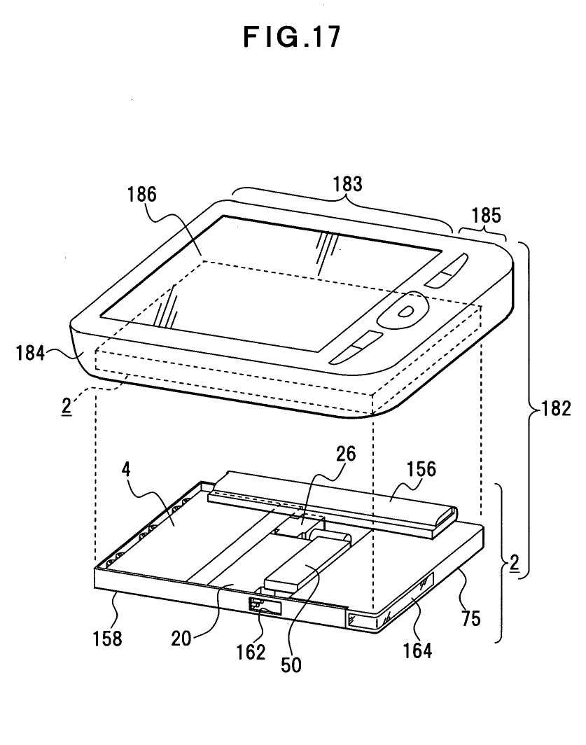

A ninth embodiment of the present invention will be described with reference to FIG. 17. FIG. 17 is a diagram showing a configuration example of a mobile information terminal called PDA (Personal Digital Assistant) on which the fuel cell device 2 is mounted. In FIG. 17, the same symbols are assigned to parts identical to those of the above-described embodiments (FIG. 13, etc.).

A PDA 182 is an example of an electronic appliance on which the fuel cell device 2 is mounted. In this PDA 182, a display panel part 183 and an input operation part 185 including a plurality of keys or the like are disposed on a cabinet part 184 as well as the above-described circuit board 82 and the like. Further, an LCD 186, for example, is disposed as a display part on the display panel part 183. The fuel cell device 2 corresponding to the cabinet part 184 is disposed on the rear part of this PDA 182. The configuration of the fuel cell device 2 is the same as described above.

In this manner, according to the PDA 182 on which the fuel cell device 2 is mounted, since operations such as replacing rechargeable batteries can be saved and a stable power supply for many hours can be obtained from the fuel cell device 2 simply by replacing the fuel, so that continuous operations can be ensured, and the convenience and mobility can be further increased.

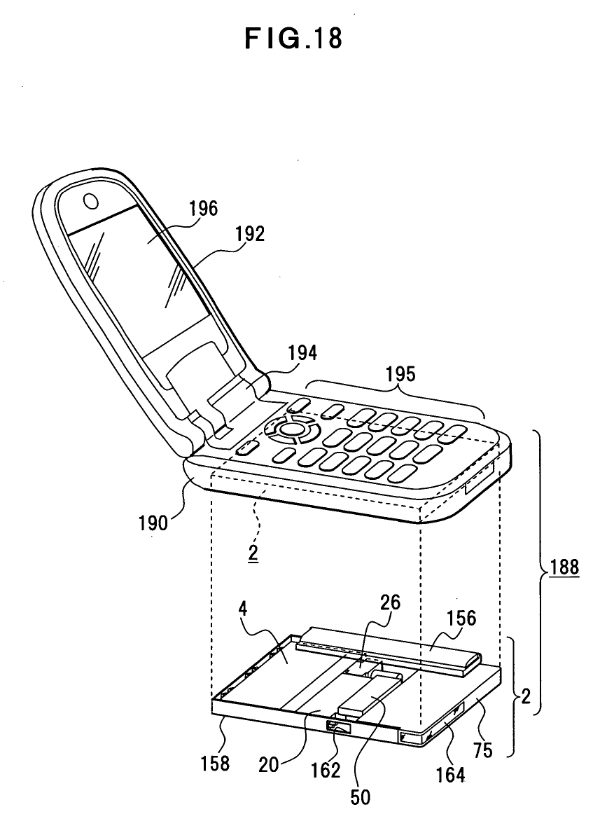

A tenth embodiment of the present invention will be described with reference to FIG. 18. FIG. 18 is a diagram showing a configuration example of a mobile phone on which the fuel cell device 2 is mounted. In FIG. 18, the same symbols are assigned to parts identical to those of the above-described embodiment (FIG. 13).

As a wireless communication device or a mobile terminal, a mobile phone 188, for example, is an example of an electronic appliance on which the fuel cell device 2 is mounted. In this mobile phone 188, a cabinet part 190 and a cabinet part 192 are connected to be openable/closable via a hinge part 194, and on the cabinet part 190, an input operation part 195 composed of a plurality of keys is disposed, and on the cabinet part 192, a display part, for example, an LCD 196 is disposed. The fuel cell device 2 is disposed on the rear part of this cabinet part 190. The configuration of the fuel cell device 2 is the same as described above.

In this manner, according to the mobile phone 188 on which the fuel cell device 2 is mounted, since operations such as replacing rechargeable batteries can be saved and a stable power supply for many hours can be obtained from the fuel cell device 2 simply by replacing the fuel, so that continuous operations can be ensured, and the convenience and mobility can be further increased.

### Other Embodiments

Next, other embodiments will be described by listing hereinbelow.

(1) Although in the above embodiments, a PC, a PDA, and a mobile phone have been exemplified as electronic appliances mounting the fuel cell device 2, other electronic appliances such as a camera and a radio may also be used. The same effects such as realizing stable operations for many hours can be expected simply by supplying the fuel without replacing rechargeable batteries or the like.

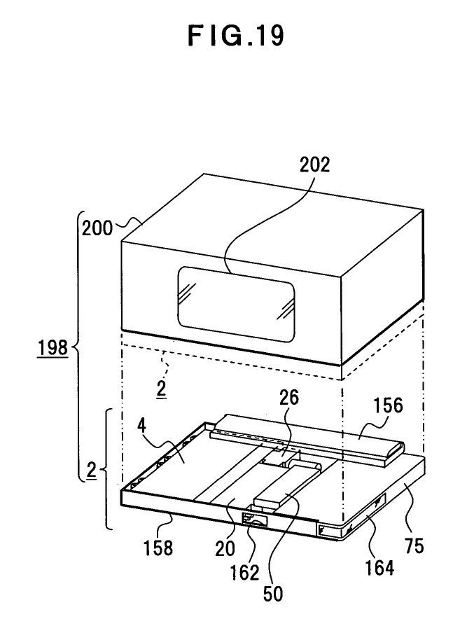

(2) As an electronic appliance in which the fuel cell device 2 is mounted, for example, as shown in FIG. 19, the fuel cell device 2 may be attached to a main body 200 of a lighting fixture 198 such as flashlights either to be removable or integrated. According to such a configuration, the same effects can be expected and convenience as a disaster prevention appliance can be increased.

A most preferred embodiment and the like of the present invention have been described above. However, the present invention is not limited to the above description; it goes without saying that various modifications and alterations may be made by a person skilled in the art on the basis of the gist of the invention that is described in the claims and disclosed in the detailed description of the invention, and that such modifications and alterations are included in the scope of the present invention.

The present invention relates to a fuel cell device, and is useful such that it can suppress amount of moisture discharged along with the exhaust air; prevent dew condensation; prevent troubles from occurring that are caused by the dew condensation in the appliance on which the fuel cell device is mounted; suppress the amount of moisture discharged from the fuel cell device; prevent dew condensation therein; and improve reliability of the appliance on which the fuel cell device is mounted.

The entire disclosure of Japanese Patent Application No. 2005-067865 including specification, claims, drawings and summary are incorporated herein by reference in its entirety.

What is claimed is:

1. A fuel cell device comprising:
a water tank recovering water separated from exhaust air of the fuel cell that generates electricity by use of a fuel; and
a path discharging the exhaust air by introducing to the water tank, wherein the path discharges the exhaust air by introducing to above the surface of the water stored in the water tank.

2. The fuel cell device of claim 1, further comprising a water absorption part disposed in the path at the downstream side of the water tank, the water absorption part absorbing moisture from the exhaust air passing thereat.

3. The fuel cell device of claim 1, further comprising a gas-liquid separation part disposed in the path at the downstream side of the water tank, the gas-liquid separation part separating moisture from the exhaust air passing thereat.

4. The fuel cell device of claim 1, wherein the fuel cell is comprised of an oxidizer electrode supplying air to one side of an electrolyte membrane and a fuel electrode supplying a fuel to the other side of the electrolyte membrane, the electrodes being disposed sandwiching the electrolyte membrane.

5. The fuel cell device of claim 1, further comprising a diluted fuel tank storing a diluted fuel diluted with water, the diluted fuel tank being integrated into the water tank.

6. The fuel cell device of claim 1, further comprising a diluted fuel tank storing a diluted fuel diluted with water, the diluted fuel tank being connected to the water tank storing the water via a pipeline.

7. The fuel cell device of claim 1, further comprising:
a stabilization circuit extracting electricity output of the fuel cell after stabilization; and
a battery to be charged by receiving the output of the stabilization circuit.

8. The fuel cell device of claim 1, further comprising:
a fuel tank storing a fuel;
a diluted fuel tank storing a diluted fuel produced by diluting the fuel supplied from the fuel tank with the water supplied from the water tank; and
an air supply part supplying the air to an oxidizer electrode of the fuel cell in which the oxidizer electrode and a fuel electrode are disposed sandwiching an electrolyte membrane.

9. The fuel cell device of claim 2, wherein the water absorption part is detachably attached to the fuel cell device.

10. The fuel cell device of claim 4, wherein the electrolyte membrane is a permeable membrane letting protons or electrons pass through.

11. The fuel cell device of claim 8, further comprising a pump disposed in a fuel supply path connecting the fuel tank and the diluted fuel tank, the pump introducing the fuel from the fuel tank to the diluted fuel tank.

12. The fuel cell device of claim 8, further comprising a pump disposed in a water supply path connecting the water tank and the diluted fuel tank, the pump introducing the water from the water tank to the diluted fuel tank.

13. The fuel cell device of claim 8, further comprising a combined tank unit in which the fuel tank and the water absorption part are combined together.

14. The fuel cell device of claim 8, further comprising a combined tank unit in which the water tank and the diluted fuel tank are combined together.

15. A fuel cell device comprising:
a water tank recovering water separated from the exhaust air of the fuel cell generating electricity by use of a fuel;
a path introducing the exhaust air to below the surface of the water stored in the water tank; and
a water absorption part disposed in the path at the downstream side of the water tank, the water absorption part absorbing moisture from the exhaust air passing thereat.

16. An electronic appliance comprising a fuel cell device in its power source part, the fuel cell device including:
a water tank recovering water separated from the exhaust air of the fuel cell generating electricity by use of a fuel; and
a path discharging the exhaust air by introducing to the water tank.

17. The electronic appliance of claim 16, further comprising a water absorption part absorbing moisture from the exhaust air passing thereat, which is disposed in the path at the downstream side of the water tank, the path discharging the exhaust air by introducing to either above or below the surface of the water stored in the water tank.

18. The electronic appliance of claim 16, further comprising:
a stabilization circuit extracting electricity output of the fuel cell after stabilization; and
a battery to be charged by receiving the output of the stabilization circuit.

19. The electronic appliance of claim 16, further comprising a fuel tank to store the fuel, which is removably attached to a cabinet part of the fuel cell device.

20. The electronic appliance of claim 16, further comprising a window in the fuel tank, from which the remaining amount of fuel can be checked.
